(19) United States
(12) Patent Application Publication
(10) Pub. No.: US 2018/0113079 A1
(43) Pub. Date: Apr. 26, 2018

(54) METHOD AND DEVICE FOR MEASURING A LONG PROFILE

(71) Applicant: NEXTSENSE GMBH, Graz (AT)

(72) Inventors: Gasser CLEMENS, Graz (AT); Kaufmann FRIEDRICH PETER, Graz (AT); Luttenberger EDUARD, Heiligenkreuz (AT); Niel ALBERT, Graz (AT)

(73) Assignee: NEXTSENSE GMBH, Graz (AT)

(21) Appl. No.: 15/560,815

(22) PCT Filed: Mar. 23, 2016
(86) PCT No.: PCT/AT2016/050073

§ 371 Date: Sep. 22, 2017

(30) Foreign Application Priority Data
Mar. 24, 2015 (AT) A 50237/2015

(51) Int. Cl. G01N 21/89; G01B 11/06; G01B 17/02; B21J 1/04

(52) U.S. Cl. CPC G01N 21/8903; G01B 11/0666; G01B 11/245; B21J 1/04; G01B 2210/54; G01B 17/02

(57) ABSTRACT

The invention relates to a method for measuring a long profile (2), in particular one at an increased temperature, wherein a cross-section of the long profile (2) is determined, wherein the long profile (2) is measured using a light section sensor (4) that is moveably mounted on a swivel device (3). The invention also relates to a device for measuring a long profile (2), in particular one at an increased temperature, comprising a measuring device for determining a cross-section of the long profile (2), wherein a swivel device (3) is provided and the measuring device is formed as a light section sensor (4), wherein the light section sensor (4) is moveably mounted on the swivel device (3). The invention further relates to a use of a device (1) of this type.

The invention relates to a method for measuring a long profile, in particular a long profile at an increased temperature, wherein a cross-section of the long profile is determined.

Furthermore, the invention relates to an apparatus tor measuring a long profile, in particular a long profile at an increased temperature, comprising a measuring device for determining a cross-section of the long profile.

The invention also relates to a use of an apparatus of this type.

From the prior art, methods are known for measuring a cross-section of a long profile, such as for example a hot rolled profile or a rolled profile at roiling temperature.

During the measuring of a hot long profile, one or more sensors must be positioned with high accuracy. For this purpose, costly mechanical supporting structures are known from the prior art, to which structures multiple sensors are attached. Particularly when measuring a long profile in continuous production operations, costly supporting structures of this type take tip a great deal of space and are laborious to install. To reduce costs, wooden planks with a defined width and/or length for comparison with a long profile to be measured are for example often placed on said profile instead of the supporting structures. A method of this type for determining dimensions of a long profile is, of course, not particularly precise.

This is addressed by the invention. The object of the invention is to specify a method of the type named at the outset with which a long profile can be measured easily and efficiently and with high accuracy.

A further object is to specify an apparatus of the type named at the outset which enables a simple and efficient and accurate measuring of a long profile. Furthermore, an object is to specify a use of an apparatus of this type.

The object is attained according to the invention in that with a method of the type named at the outset, the long profile is measured with a light section sensor displaceably mounted on a swivel device.

One advantage achieved by the invention can in particular be seen in that, by means of the light section sensor displaceably mounted on the swivel device, a cross-section of a long profile can be reconstructed from single images that are recorded from several different directions. Furthermore, the sensor positioning thus does not need to be subjected to any stringent accuracy requirements. Accurate measurements without costly mechanical supporting structures are thus possible, which particularly for measuring a hot long profile yields significant advantages. In principle, with the method according to the invention, a cross-section of a cold long profile, or a long profile at room temperature, can also be determined; however, this is particularly advantageous when measuring a cross-section of a hoi long profile, since it is thereby more difficult to provide a measuring frame with unchanging geometry. With a method according to the invention, a cross-section of a long profile formed in any desired manner, such as for example a rail, a beam or a pipe, in particular rolled products, but also extruded plastic profiles, for example, can be ascertained or determined. By means of the displaceable mounting of the light section sensor, a long profile can be measured flexibly and preferably from all sides, wherein the light section sensor is displaced at a distance from the long profile. Preferably, the cross-section is determined by a single light sensor mounted on the swivel device, whereby additional costs due to a use of multiple sensors are avoided. The light section sensor is preferably moved mechanically in or by the swivel device.

It is advantageous if a roughly ring-shaped movement is performed by the light section sensor. For this purpose, the light section sensor is guided along a circumference of the long profile around and at a distance from said profile, wherein a measuring plane is advantageously approximately at a right angle or perpendicular to a longitudinal axis of the long profile. For this purpose, the swivel device is preferably embodied such that the light section sensor is moved along said device on a circular path, wherein the light section sensor is preferably moved or displaced in an automated manner. However, it can also be provided that the light section sensor is moved semi-automatically or manually. During the movement or displacement of the light section sensor, multiple single images are recorded by said sensor from different directions in order to subsequently reconstruct an entire cross-section of the long profile.

It is advantageous if at least two, in particular three or more, laser beams are shined onto the long profile by the light section sensor. In this manner, the entire system is rendered insensitive to measuring errors that occur when a measuring plane does not lie exactly at a right angle to the axis of the long profile being checked. An exact positioning of the light section sensor is thus unnecessary. The cross-section of the long profile is determined using the light section technique. The laser beams are thereby embodied to be divergent and illuminate what is referred to as a measuring field.

It is advantageous if an angle between a light section plane and a longitudinal axis of the long profile is calculated from measurement data, wherein a correction of the recorded cross-section is performed using this angle. In this manner, accurate measurements are then even possible when the light section sensor is not aligned exactly at a right angle to the longitudinal axis of the long profile.

Expediently, the cross-section of the long profile is determined by combining multiple single images. For this purpose, a plurality of single images are recorded by the light section sensor from different positions of the same. A quantity of the single images thereby depends on the cross-section of the long profile, but can be on an order of magnitude of approximately 10 to 200. It can be provided that recorded regions of two or more single images of the long profile at least partially overlap or correspond to one another. The quantity of single images can be used to increase an accuracy or robustness of the process. Furthermore, in this manner aberrations in the data, such as for example scale, in individual measurements can be detected by averaging, error compensation and/or consistency testing.

It is beneficial if at least partial information about a change in position of the light section sensor is established from measurement data of the light section sensor itself. This is beneficial for subsequently compiling the cross-section of the long profile. It can be provided that individual degrees of freedom of the light section sensor or an entire change in position of the same are established.

Alternatively thereto or in combination therewith, at least partial information about a change in position of the light section sensor can be established using an angle transducer and/or a displacement transducer. However, for this purpose it can be sufficient to know an angle or a path only approximately, that is, the angle transducer or displacement transducer does not need to be subjected to accuracy requirements on the order of magnitude of the measurement accuracy. With the angle transducer and/or displacement transducer, it is possible to determine only one of several degrees for freedom of a position of the light section sensor. Thus, only the rotation of the light section sensor can be determined, for example, whereas a translation in the x and/or y direction is determined via the measurement itself. An angle transducer can in principle detect an angle of rotation or the change therein for the light section sensor, whereas a displacement transducer can detect a translation in the x and/or y direction or a traveled distance for the light section sensor. It can also be provided that an angle transducer and a displacement transducer are combined, and that both an angle of rotation and also a distance are thus detected and/or determined. If pipes are being measured, for example, it is sufficient to only approximately know an angle, since the rotation of the single images in the case of an approximately circular cross-section has only a small influence on an accuracy of the measurement.

Furthermore, it can also be provided additionally or in combination that at least partial information about a change in position of the light section sensor is established via reference objects located in a measuring field. The reference objects are thereby advantageously arranged statically and stationarily in the measuring field and can be embodied as cylinders, for example.

It can thereby be advantageous to establish or to determine at least partial information with any desired combination of the methods indicated above. However, it can also be provided that only a single one of said methods is used depending on the cross-section of the long profile to be measured. It is thereby consistently beneficial if an accuracy of the swivel device has no or little influence on an accuracy of end results.

Optionally, it can be provided that the swivel device is moved with the light section sensor along a longitudinal axis of the long profile. For this purpose, at least one roiling element and/or sliding element, such as a roller or a wheel for example, can be attached to the swivel device. In this manner, a cross-section of the long profile is determined across the entire length thereof. Alternatively to the swivel device, the long profile itself can also be moved along its longitudinal axis. The rolling element and/or sliding element can also be used to position the swivel device about the long profile, for example for horizontally sliding the device in.

Furthermore, it is advantageous if the swivel device is, in order to measure a long profile, detachably mounted above the long profile and such that it at least partially surrounds the long profile. Accordingly, the swivel device is embodied to be mobile or portable and, in order to measure a long profile, temporarily mounted in the vicinity of the long profile. The swivel device with the light section sensor is for this purpose preferably embodied to be manageable and light, so that it can be carried and mounted by one person without significant effort. In contrast to a mechanical supporting structure, no costly and space-consuming apparatus is thus necessary.

It is also advantageous if a cross-section of the long profile is determined via stationary reference objects, in particular reference objects located in the measuring field. In this manner, long profiles with a uniform cross-section, such as straight pipes, can also be measured. With the aid of the mountable reference objects, the single images from the light sensor can subsequently be combined. For this purpose, the reference objects can be embodied as cylinders, for example.

It is further beneficial if the light section sensor is moved in an automated manner. A movement of this type can for this purpose be controlled by a control unit and individually adjusted to the long profile to be measured. The light section sensor can, however, also be moved or displaced semi-automatically or manually. It is also possible for there to be an ability to switch between automated and manual movement.

It can preferably be provided that data are transmitted without cables from the light section sensor to an evaluation unit. The transmission without cables or wires can, for example, be carried out via WLAN or Bluetooth. The evaluation unit can be a tablet computer on which measurement results are displayed and evaluated, it is thus also possible to subsequently intervene directly in a measurement that is in progress. At the same time, the evaluation unit can also be embodied as a control unit. Even though it can also be provided that movements of the light section sensor in or on the swivel device are controlled via cables that can be rolled up and unrolled, the entire light section sensor is preferably operated without cables in order to avoid unnecessary hindrances caused by cables during the movement of the sensor.

The further object is attained if, in an apparatus of the type named at the outset, a swivel device is provided and the measuring device is embodied as a light section sensor, wherein the light section sensor is displaceably mounted on the swivel device.

One advantage thus achieved can in particular be seen in that, because of the embodiment of the swivel device and the light section sensor displaceably mounted thereon, a long profile can be measured without the light section sensor being subjected to special accuracy requirements. With this design, a creation of multiple single images is possible, which images can subsequently be compiled. In addition, with an apparatus of this type, a measurement of virtually any desired profile cross-sections is possible, such as for example of a rail, a beam, or the like. The swivel device can be embodied to be purely mechanical, whereby a movement of the light section sensor also occurs mechanically. The light section sensor is always arranged at an adequate distance from the long profile, so that a hot long profile can also be measured without overheating the light section sensor or the apparatus. In principle, with the apparatus according to the invention, a cross-section of a cold long profile, or a long profile at room temperature, can also be determined; however, this is particularly advantageous when measuring a cross-section of a hot long profile, since it is thereby more difficult to provide a measuring frame with unchanging geometry.

It is advantageous if the light section sensor can be displaced on an approximately circular path about the long profile. Advantageously, the sensor is thereby always aligned roughly perpendicularly to the long profile. For this purpose, the swivel device can also be embodied as an approximate circular path, wherein a section of the ring-shaped swivel arrangement can be omitted. A movement of the light section sensor on the swivel device thereby advantageously takes place in an automated manner. However, it can also be provided that the movement or displacement of the light section sensor can be controlled semi-automatically or manually.

It is beneficial if the swivel device comprises at least one mounting device for the detachable mounting of the apparatus for a measuring procedure. As a result, the apparatus is embodied to be mobile, whereby it can be mounted about the long profile to be measured in order to conduct a measuring procedure. Furthermore, the swivel device can be detached from its mount about the long profile when not in use. The mounting device can be attached to an upper end of the swivel device, whereby the mounting device can simultaneously be used as a carrying device. The apparatus is thus embodied to be portably moveable, wherein it can preferably be carried and mounted around the long profile by one person and without additional tools. Alternatively, the at least one mounting device can be laterally attached, to the swivel device and embodied such that the apparatus can be hooked-in around the long profile and/or hooked-in such that it partially surrounds the long profile. For example, the device can be formed from two sections that can be arranged on two sides of the swivel device. The mounting device can also be embodied to be adjustable, so that it can be used universally.

Optionally, at least one rolling element and/or sliding element can be provided in order to displace the apparatus along a longitudinal axis of the long profile via said elements. The at least one roiling element and/or sliding element can, for example, be mounted laterally on the swivel device. Furthermore, the apparatus can comprise a stationary mating piece corresponding to the rolling element, for example, a rail, to enable a longitudinal movement of the apparatus. It is thus possible to determine a cross-section of a hot long profile along the entire length thereof Alternatively, it is also possible to move the long profile itself along the longitudinal axis thereof, as occurs for example during a continuous production process, for example during the rolling of rails or the extruding of plastic profiles. The rolling element and/or sliding element can also be used to hook-in or slide-in the apparatus around the long profile.

It is also advantageous if an evaluation unit is provided, wherein a data transmission between the evaluation unit and the light section sensor takes place without cables. Advantageously, the evaluation unit can thereby be embodied as a tablet computer and the data transfer without cables or wires can occur via WLAN or Bluetooth. Even though it can also be provided that movements of the light section sensor in or on the swivel device are controlled via cables that can be rolled, up and unrolled, it is beneficial if the entire apparatus is tree of cables, so that a movement of the light section sensor is also not impeded by cables. It can also be beneficial if the evaluation unit can simultaneously be used as a control unit, so that it can be used to control a movement and/or a measurement by the light section.

It is also advantageous if an optical and/or acoustic signal-generating device is provided. Particularly when measuring a long profile at an increased temperature or a hot long profile, a device of this type is beneficial for protecting the apparatus against an overheat or to warn thereof. The optical and/or acoustic signal-generating device can, for example, be embodied as a siren that also comprises a warning light and can emit a warning signal when a defined temperature is exceeded.

Expediently, stationary reference objects can be arranged within the swivel device, preferably in a measuring field of the light section sensor. It is thus also possible to measure long profiles without distinctive characteristics, such as straight pipes, for example. With the aid of the reference objects, which can for example be embodied as cylinders, a combination of recorded single images from the light section sensor is possible. Using the reference objects, at least partial information about a change in movement of the light section sensor can also be established.

A use of an apparatus according to the invention advantageously takes place when determining a cross-section of a long profile at an increased temperature in continuous production operations.

Additional features, advantages and effects follow from the exemplary embodiments described below. The drawings which are thereby referenced show the following:

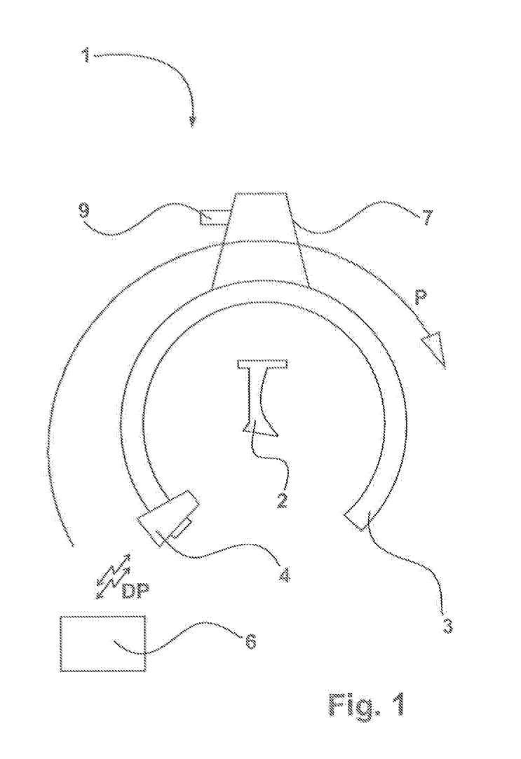

FIG. 1 A schematic illustration of an apparatus according to the invention;

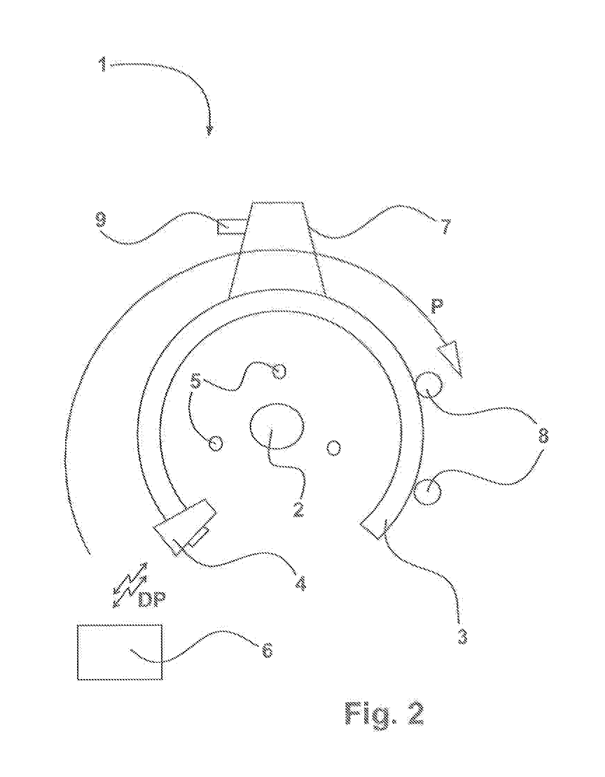

FIG. 2 A schematic illustration of a further apparatus according to the invention;

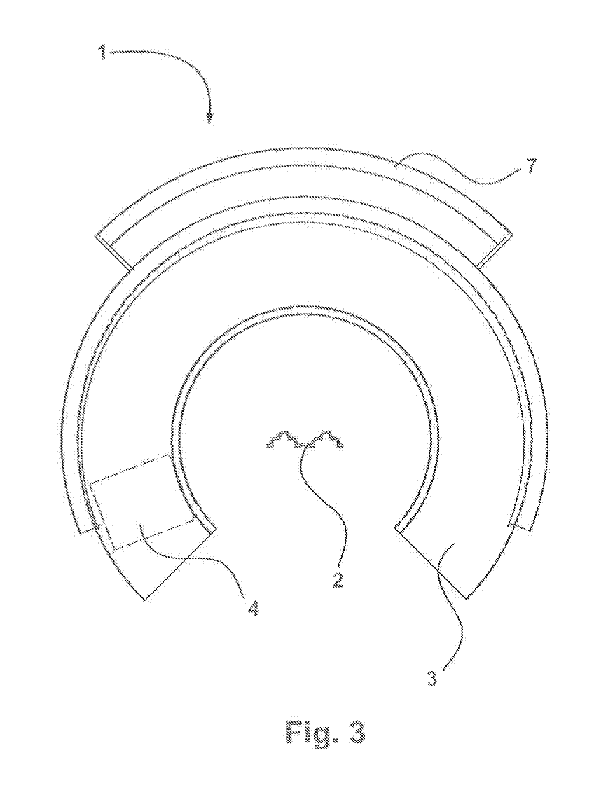

FIG. 3 A schematic illustration of a further apparatus according to the invention.

FIG. 1 shows a section through a schematic illustration of an apparatus 1 according to the invention for measuring a long profile 2 along with the long profile 2. The apparatus 1 comprises a light section sensor 4 and a mechanical swivel device 3, on which the light section sensor 4 is displaceably mounted. The apparatus 1 is particularly suited to measuring a long profile 2 at an increased temperature, such as for example a rolled profile at rolling heat like a rail or an I-beam, since a measurement can be performed in a non-contact and preferably automated manner. According to FIG. 1, the swivel device 3 is embodied in a ring shape so that the light section sensor 4 can be displaced 360° thereon. In FIG. 1, the movement or displacement direction of the light section sensor 4 is illustrated by an arrow P.

It is possible to determine an entire cross-section of the long profile 2 with only a single light section sensor 4. The sensor records multiple single images that are subsequently combined to reproduce the cross-section of the long profile 2. Approximately 10 to 200 single images can be recorded, for example, and the cross-section of the long profile 2 can then be determined by a combination of said images. For the measurement of the long profile 2, the light section sensor 4 is embodied such that it emits two, preferably three, laser beams onto the long profile 2. The laser beams are thereby embodied to be divergent and illuminate what is referred to as a measuring field on the long profile 2.

The apparatus 1 can also comprise an angle transducer and/or displacement transducer in order to determine a change in position of the light section sensor 4. However, for this purpose it can be sufficient to know an angle or a path only approximately, that is, the angle transducer and/or displacement transducer do not need to be subjected to accuracy requirements on the order of magnitude of the measurement accuracy. With the angle transducer and/or displacement transducer, it is possible to determine only one of several degrees of freedom of a position of the light section sensor. Thus, only the rotation of the light section sensor 4 can be determinable, for example, whereas a translation in the x and/or y direction can be determined via the measurement itself.

It is beneficial if the entire apparatus 1 is operated without cables. For this purpose, the light section sensor 4 can be controllable without cables or wires, for example via WLAN or Bluetooth. Furthermore, an evaluation unit 6 can be provided which, on the one hand, evaluates data recorded or generated by the light section sensor 4 and, on the other hand, controls said sensor. The evaluation unit 6 can, for example, be embodied as a tablet computer and can communicate with the light section sensor 4 via WLAN. In FIG. 1, the data transmission without cables between the light section sensor 4 and the evaluation unit 6 is illustrated by a double arrow DP. It can also be provided that a measuring procedure can be directly influenced using the evaluation unit 6.

In particular for the measurement of a hot long profile 2, the apparatus 1 can comprise an optical and/or acoustic signal-generating device 9 in order to warn of an overheat of the apparatus 1. This device 9 can, for example, be arranged at an upper end of the swivel device 3 and be embodied as a lighted siren.

The apparatus 1 is preferably embodied to be portable and comprises a mounting device 7 for the detachable mounting of said apparatus for a measuring procedure. For this purpose, the apparatus 1 can be mounted, for example hooked-in, in particular above or partially surrounding the long profile 2, for which purpose the mounting device 7 can be arranged at an upper end of the apparatus 1. After a completed measuring procedure, the apparatus 1 or the mounting device 7 can be detached again. At the same time, the mounting device 7 can be embodied such that the apparatus 1 can be carried by one person. For this purpose, the apparatus 1 is preferably embodied to be manageable or small and light, so that it can be carried and mounted by one person without significant inconvenience or considerable effort.

FIG. 2 shows a section through a further apparatus 1 according to the invention for measuring a long profile 2 along with the long profile 2. The mounting device 7 can thereby be used primarily as a carrying device. The apparatus 1 comprises two roiling elements 8, via which the apparatus 1 can be hooked-in around the long profile 2.

The rolling elements 8 can be arranged at a distance from one another on the swivel device 3 on one side of the apparatus 1. Additionally, rails can be provided which enable a displacement of the device 1 in the direction of a longitudinal axis of the long profile 2.

As an alternative to the rolling elements 8 and/or sliding elements, or in addition thereto, the apparatus 1 can for example comprise two mounting devices 7 which are attached to two sides of the swivel device 3 and via which the apparatus 1 can, in order to perform a measuring procedure, be hooked-in such that the swivel device 3 at least partially surrounds the long profile 2. The mounting devices 7 can also be embodied to be adjustable in multiple directions, so that the apparatus 1 can be used as flexibly as possible. It is further beneficial if the apparatus 1 additionally comprises a carrying device mounted at an upper end of the same.

In FIG. 2, a straight long profile 2 is shown with a roughly circular cross-section. A long profile 2 of this type is difficult to measure with the light section sensor 4 due to the absence of distinctive characteristics. For this reason, reference objects 5 are provided which can be detachably mounted in a measuring field of the light section sensor 4 in order to enable a combination of single images from the light section sensor 4 with the aid of said reference objects. The reference objects 5 can be embodied as cylinders, for example.

The swivel device 3 can, for example, be formed from two roughly ring-shaped rails that can be displaced relative to one another, wherein the light section sensor 4 can be arranged on one of the rails and is moved about the long profile 2 with said rail. Alternatively, it can also be provided that a carriage with the light section sensor 4 can be displaced in a torus-shaped housing, wherein the carriage with the light section sensor 4 is mounted and/or displaceable inside the housing. An illustration of an apparatus 1 of this type is shown in FIG. 3. For this purpose, friction wheels can for example be arranged on the carriage, which friction wheels are moved in the housing in an automated manner. The swivel device 3 can, however, also be embodied in any other manner desired. In FIG. 3, the mounting device 7 that is specifically embodied as a carrying device is illustrated.

In a method according to the invention, a cross-section of an in particular hot long profile 2 is determined. In particular, a cross-section is determined in continuous operations or during a production process for a long profile 2. For this purpose, the long profile 2 is measured using a light section sensor 4 that is mounted on a mechanical swivel device 3. To determine the cross-section of the long profile 2, the light section sensor 4 is guided around a circumference of the long profile 2 and guided about the long profile 2 at a distance therefrom. In particular three laser beams are shined onto the long profile 2, and multiple or a plurality of single images are subsequently created from many different directions. For this purpose, it is beneficial if the light section sensor 4 or the measuring plane thereof lies roughly at a right angle or perpendicularly to a longitudinal axis of the long profile 2. With a use of three laser beams, however, this is not absolutely necessary, since a system of this type is insensitive to measuring errors. The plurality of single images is used to increase an accuracy of a result and a robustness of the process, and to detect aberrations in data. For example, scale can be detected in individual measurements by averaging, error compensation, and/or consistency testing and can be subsequently eliminated.

The swivel device 3 is furthermore embodied such that a roughly ring-shaped movement along a circular path is performed by the light section sensor 4 and the light section sensor 4 is guided roughly 360° around a circumference of the long profile 2.

The long profile 2 can be measured in continuous operations, wherein said profile is moved along its longitudinal axis and the swivel device 3 with the light section sensor 4 is installed stationarily. Alternatively, it is also possible that the swivel device 3 with the light section sensor 4 is moved along the longitudinal axis of the long profile 2.

The swivel device 3 with the light section sensor 4 can be embodied to be portable and, for a measuring procedure, detachably mounted around the long profile 2. The swivel device 3 is thereby installed such that it at least partially surrounds the long profile 2 to be measured, as shown in FIGS. 1 and 2. The swivel device 3 with the light section sensor 4 can, for a measuring procedure, be installed temporarily around the long profile 2 and removed again after a completion of said measuring procedure. In this manner, a flexible measurement of a cross-section of the long profile 2 is possible without a costly and heavy frame structure needing to be permanently installed.

It can furthermore be provided that data can be transmitted from the light section sensor 4 to an evaluation unit 6, wherein a transmission is preferably carried out without cables or wires. During the measurement of the long profile 2, multiple single images are created from different directions, which images are combined by the evaluation unit 6. The light section sensor 4 can also be controlled with the evaluation unit 6.

If a simple cross-section, for example of a straight pipe, is to be determined, stationary reference objects 5 can be mounted in a measuring field of the light section sensor 4 in order to enable a combination of the single images despite the uniform shape of the long profile 2.

With an apparatus 1 according to the invention, a cross-section of a long profile 2 embodied in any desired manner can be determined simply, since only a single light section sensor 4 is necessary.

1. A method for measuring a song profile (2), in particular a long profile (2) at an increased temperature, wherein a cross-section of the long profile (2) is determined, characterized in that the long profile (2) is measured using a light section sensor (4) displaceably mounted on a swivel device (3).

2. The method according to claim 1, characterized in that a roughly ring-shaped movement is performed by the light section sensor (4).

3. The method according to claim 1, characterized in that at least two, in particular three or more, laser beams are shined onto the long profile (2) by the light section sensor (4).

4. The method according to claim 1, characterized in that the cross-section of the long profile (2) is determined by combining multiple single images.

5. The method according to claim 1, characterized in that at least partial information about a change in position of the light section sensor (4) is established from measurement data from the light section sensor (4) itself.

6. The method according to claim 1, characterized in that at least partial information about a change in position of the light section sensor (4) is established using an angle transducer and/or a displacement transducer.

7. The method according to claim 1, characterized in that at least partial information about a change in position of the light section sensor (4) is established via reference objects (5) located in a measuring field.

8. The method according claim 1, characterized in that the swivel device (3) is, during the measurement of the long profile (2), detachably mounted above the long profile (2) and such that it at least partially surrounds the long profile (2).

9. The method according to claim 1, characterized in that a cross-section of the long profile (2) is determined via stationary reference objects (5), in particular reference objects (5) located in the measuring field.

10. The method according to claim 1, characterized in that the light section sensor (4) is moved in an automated manner.

11. The method according to claim 1, characterized in that data are transmitted from the light section sensor (4) to an evaluation unit (6) without cables.

12. An apparatus (1) for measuring a long profile (2), in particular a long profile (2) at an increased temperature, comprising a measuring device for determining a cross-section of the long profile (2), characterized in that a swivel device (3) is provided and the measuring device is embodied as a light section sensor (4), wherein the light section sensor (4) is displaceably mounted on the swivel device (3).

13. The apparatus (1) according to claim 12, characterized in that the light section sensor (4) can be displaced on approximately a circular path about the long profile (2).

14. The apparatus (1) according to claim 12, characterized in that the swivel device (3) comprises at least one mounting device (7) for the detachable mounting of the apparatus (1) for a measuring procedure.

15. The apparatus (1) according claim 12, characterized in that an evaluation unit (6) is provided, wherein a data transmission between the evaluation unit (6) and the light section sensor (4) takes place without cables.

16. The apparatus (1) according to claim 12, characterized in that an optical and/or acoustic signal-generating device (9) is provided.

17. The apparatus (1) according to claim 12, characterized in that stationary reference objects (5) are arranged within the swivel device (3), preferably in a measuring field of the light section sensor (4).

18. A use of an apparatus (1) according to claim 12 for determining a cross-section of a long profile (2) at an increased temperature in continuous production operations.
